(19) United States
(12) Patent Application Publication
(10) Pub. No.: US 2024/0236393 A1
(43) Pub. Date: Jul. 11, 2024

(54) SYSTEM AND METHOD OF PRESELECTIONS FOR MEDIA PROCESSING, STREAMING AND PLAYBACK

(71) Applicant: MEDIATEK INC., Hsinchu (TW)

(72) Inventors: Xin Wang, San Jose, CA (US); Lulin Chen, San Jose, CA (US)

(21) Appl. No.: 18/407,566

(22) Filed: Jan. 9, 2024

Related U.S. Application Data
(60) Provisional application No. 63/479,189, filed on Jan. 10, 2023.

(51) Int. Cl. H04N 21/262; H04N 21/236; H04N 21/239; H04N 21/438; H04N 21/84; H04N 21/845

(52) U.S. Cl. CPC H04N 21/26258; H04N 21/236; H04N 21/2393; H04N 21/438; H04N 21/84; H04N 21/8456

(57) ABSTRACT

In certain aspects of the disclosure, methods, and systems of preselections for media processing, streaming and playback are provided. The method includes generating a unified manifest containing a media presentation description for a media content and preparing a media presentation of the media content accordingly, wherein the unified manifest lists all media components and tracks in ISO Base Media File Format (ISOBMFF) files related to the media content and supports preselections in Dynamic Adaptive Streaming over HTTP; and transmitting the unified manifest to a streaming and playback client.

### CROSS-REFERENCE TO RELATED APPLICATION(S)

This application claims the benefits of U.S. Provisional Application Ser. No. 63/479,189, entitled “SYSTEM AND METHOD OF PRESELECTIONS FOR MEDIA PROCESSING, STREAMING AND PLAYBACK” and filed on Jan. 10, 2023, which is expressly incorporated by reference herein in its entirety.

### BACKGROUND

### Field

The present disclosure relates generally to content delivery, and more particularly, to systems and methods of preselections for media processing, streaming and playback.

### Background

The statements in this section merely provide background information related to the present disclosure and may not constitute prior art.

In the latest DASH (Dynamic Adaptive Streaming in HTTP) and ISOBMFF (ISO Base Media File Format) specifications, a preselection is defined as follows:
In the context of DASH: a set of media content components that are intended to be consumed jointly; and
In the context of ISOBMFF: a set of one or more tracks representing one version of the media presentation for simultaneous decoding or presentation.

In ISOBMFF, a track belonging to a preselection is signaled by a presence of a PreselectionGroupBox within the track, and all tracks belonging to a preselection are encapsulated in a file. This track-level signaling and file-container approach has a number of issues, when coming to deal with flexible (and late) binding between tracks and preselections:
if a track is added to a new preselection, the track needs to be modified to contain a new PreselectionGroupBox for the new preselection;
if a track is removed from an existing preselection, the track needs to be modified to delete the PreselectionGroupBox for the existing preselection;
if a new track is added to an existing preselection in a file of tracks, the track needs to be added to the file containing all other tracks in the preselection, and modified to contain the PreselectionGroupBox for the existing preselection; and
when a new preselection is introduced to a file of tracks, all the tracks belonging the new preselection need to add the PreselectionGroupBox for the new preselection; and
when an existing preselection is removed from a file of tracks, all the tracks belonging the preselection need to remove the PreselectionGroupBox for the existing preselection.

These issues with flexible (and late) binding all involve track and file rewriting, which is in many cases difficult and expensive in content preparation and delivery:
Live streaming: different variant tracks of a same live stream are usually generated by different encoders and packagers. Writing these tracks into a single file in real time and modifying them for preselections can cause considerable latency in live streaming; and
On-demand streaming, downloading and sideloading: when content in these delivery modes needs to be updated for flexible (and late) binding with preselections, it is going to be expensive to re-write all the files.

Therefore, a heretofore unaddressed need exists in the art to address the deficiencies and inadequacies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with the disclosed subject matter, systems and methods are provided, such as for preselections for media processing, streaming and playback.

In one aspect, the disclosure relates to a method of preselections for media processing, streaming and playback. The method comprises generating a unified manifest containing a media presentation description (MPD) for a media content and preparing a media presentation of the media content accordingly, wherein the unified manifest lists all media components and tracks infiles related to the media content (for example, in ISO Base Media File Format (ISOBMFF) files) and supports preselections (for example, in Dynamic Adaptive Streaming over HTTP (DASH)); and transmitting the unified manifest to a streaming and playback client.

In some embodiments, the MPD comprises a series of periods that divide the media content into different time portions; each period including a number of preselections; each preselection containing a number of adaptation sets; each adaptation set containing a number of representations; and each representation containing a number of segments. In some embodiments, the adaptation sets and the preselections conform to the DASH.

In some embodiments, the unified manifest is configured such that when coming to signaling their adaptation switching and preselection binding relationships, it leaves the media components and tracks in files alone and untouched.

In some embodiments, the unified manifest contains sufficient metadata and constructs for signaling their adaptation switching relationship, such that any modification of the relationship does not involve any change to the corresponding media components and tracks in files.

In some embodiments, the unified manifest is in one of a standard form used to derive manifests for DASH and HTTP (Hypertext Transfer Protocol) Live Streaming (HLS); a DASH form used to generate DASH manifests for streaming and playback clients; and an HLS form used to generate HLS playlists for HLS clients.

In some embodiments, the unified manifest is convertible or customizable into a DASH manifest or an HLS playlist for the streaming and playback client, based on client characteristics including capabilities, geolocations, and/or membership levels.

In some embodiments, the method further comprises generating an ISOBMFF file according to the unified manifest to encapsulate all the media components related to the media content to be either streamed or downloaded as a single file to the streaming and playback client.

In another aspect, the disclosure relates to a method of preselections for media processing, streaming and playback performed at a streaming and playback client. The method includes requesting and receiving a unified manifest containing an MPD for a media content, wherein the unified manifest lists all media components and tracks in files related to the media content (for example, ISOBMFF files) and supports preselections (for example, in DASH); and requesting and receiving segments identified by the unified manifest based on conditions of communication network and the streaming and playback client.

In some embodiments, the method further comprises downloading desired media components of the media presentation over desired periods of time.

In some embodiments, the MPD comprises a series of periods that divide the media content into different time portions; each period including a number of preselections; each preselection containing a number of adaptation sets; each adaptation set containing a number of representations; and each representation containing a number of segments. In some embodiments, the adaptation sets and the preselections conform to the DASH.

In some embodiments, the unified manifest is configured such that when coming to signaling their adaptation switching and preselection binding relationships, it leaves the media components and tracks in files alone and untouched.

In some embodiments, the unified manifest contains sufficient metadata and constructs for signaling their adaptation switching relationship, such that any modification of the relationship does not involve any change to the corresponding media components and tracks in files.

In some embodiments, the unified manifest is in one of a standard form used to derive manifests for DASH and HLS; a DASH form used to generate DASH manifests for streaming and playback clients; and an HLS form used to generate HLS playlists for HLS clients.

In some embodiments, the unified manifest is convertible or customizable into a DASH manifest or an HLS playlist for the streaming and playback client, based on some client characteristics including capabilities, geolocations, and/or membership levels.

In some embodiments, an ISOBMFF file can be generated according to the unified manifest to encapsulate all the media components related to the media content to be either streamed or downloaded as a single file to the streaming and playback client.

In yet another aspect, the disclosure relates to a system of preselections for media processing, streaming and playback. The system comprises a unified manifest generation and media presentation preparation module configured to generate a unified manifest containing an MPD for a media content and prepare a media presentation of the media content accordingly, wherein the unified manifest lists all media components and tracks in ISOBMFF files related to the media content and supports preselections in DASH; a manifest deliver module configured to transmit the unified manifest to a streaming and playback client; a media segment delivery module configured to deliver segments identified by the unified manifest to the streaming and playback client; and a file download module configured for the streaming and playback client to download desired media components of the media presentation over desired periods of time.

In some embodiments, the MPD comprises a series of periods that divide the media content into different time portions; each period including a number of preselections; each preselection containing a number of adaptation sets; each adaptation set containing a number of representations; and each representation containing a number of segments; wherein the adaptation sets and the preselections conform to the DASH.

In some embodiments, the unified manifest is configured such that when coming to signaling their adaptation switching and preselection binding relationships, it leaves the media components and tracks in files alone and untouched.

In some embodiments, the unified manifest contains sufficient metadata and constructs for signaling their adaptation switching relationship, such that any modification of the relationship does not involve any change to the corresponding media components and tracks in files.

In some embodiments, the unified manifest is in one of a standard form used to derive manifests for DASH and HLS; a DASH form used to generate DASH manifests for streaming and playback clients; and an HLS form used to generate HLS playlists for HLS clients.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 shows an exemplary configuration of a generic adaptive streaming system.

FIG. 2 shows an exemplary manifest that includes a media presentation description (MPD) in one illustrative view.

FIG. 3 shows the exemplary manifest shown in FIG. 2 in another illustrative view.

FIG. 4 shows an exemplary media presentation with preselections, according to some embodiments.

FIG. 5 shows an exemplary configuration of an adaptive streaming system supporting preselections in DASH and ISOBMF, according to some embodiments.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In view of the above-mentioned deficiencies and inadequacies, this disclosure provides a unified (or master) manifest approach to supporting preselections in Dynamic Adaptive Streaming in HTTP (DASH) and ISO Base Media File Format (ISOBMFF), as an alternative to the existing approach to add additional metadata on the ISOBMFF level to represent the “MPEG DASH Preselection” concept and to be sufficient to construct manifests for DASH and HTTP (Hypertext Transfer Protocol)Live Streaming (HLS).

In one aspect, the disclosure relates to a method of preselections for media processing, streaming and playback performed at a server. The method comprises generating a unified manifest containing a media presentation description (MPD) for a media content and preparing a media presentation of the media content accordingly, wherein the unified manifest lists all media components and tracks in ISOBMFF files related to the media content and supports preselections in DASH; and transmitting the unified manifest to a streaming and playback client.

In some embodiments, the media presentation comprises a plurality of media components such as audio, video, text, metadata, and/or subtitles that can be sent from a server to a client such as a streaming and playback client for being jointly played by the client. Those media components are typically encoded individually into separate media streams and next, they are encapsulated into multiple media segments, either together or individually, and sent from the server to the client for being jointly played by the latter. Practically, several versions of the same media component are provided so that the client can select one version as a function of its characteristics (e.g., resolution, computing power, and bandwidth). Each of the alternative versions is described and media data are segmented into small temporal segments.

In some examples, a compact description of the media content of a media presentation can be associated with HTTP Uniform Resource Locations (URLs). Such an association is typically described in a file called the unified manifest or the MPD. In addition to the association, each media content is split as a function of periods of time in the media presentation preparation. The time decomposition is also described in the MPD. Accordingly, the MPD defines the association between HTTP URLs and the compact description of each component from media content over each period of time. Each media content component can be encapsulated into multiple independent media segments corresponding to these periods of time. The number of media components can change from one period to another and/or their properties may also vary from one period to another. This decomposition into time period is represented in DASH by a Period element. This allows a client to download desired media content components of a media presentation over desired periods of time.

In DASH, the unified manifest is an XML file. There are other manifest-based streaming solutions like Smooth Streaming, also using XML file, or like HTTP Live Streaming (HLS) rather using plain text file for the manifest, also called playlist. As preferred embodiments, DASH is used as streaming protocol however, the descriptive information added in the unified manifest would provide the same effects in these other solutions. In some examples, the unified manifest file gathers a set of descriptors that specify descriptive information on the media samples described in the manifest. A descriptor may be structured elements like for example XML nodes (elements and/or attributes) or may be described with JSON (JavaScript® Object Notation) or even in plain text format provided that keywords or comments are dedicated to convey these descriptors.

In some embodiments, the MPD comprises a series of periods that divide the media content into different time portions; each period including a number of preselections; each preselection containing a number of adaptation sets; each adaptation set containing a number of representations; and each representation containing a number of segments; wherein the adaptation sets and the preselections conform to DASH.

In some embodiments, the unified manifest is configured such that when coming to signaling their adaptation switching and preselection binding relationships, it leaves the media components and tracks in files alone and untouched.

In some embodiments, the unified manifest contains sufficient metadata and constructs for signaling their adaptation switching relationship, such that any modification of the relationship does not involve any change to the corresponding media components and tracks in files.

In some embodiments, the unified manifest is in one of a standard form used to derive manifests for DASH and HLS; a DASH form used to generate DASH manifests for streaming and playback clients; and an HLS form used to generate HLS playlists for HLS clients.

In some embodiments, the unified manifest is convertible or customizable into a DASH manifest or an HLS playlist for the streaming and playback client, based on client characteristics including capabilities, geolocations, and/or membership levels.

In some embodiments, the method further comprises generating an ISOBMFF file according to the unified manifest to encapsulate all the media components related to the media content to be either streamed or downloaded as a single file to the streaming and playback client.

In another aspect of the disclosure, the method of preselections for media processing, streaming and playback is performed at a streaming and playback client. The method includes requesting and receiving a unified manifest containing an MPD for a media content, wherein the unified manifest lists all media components and tracks in ISOBMFF files related to the media content and supports preselections in DASH; and requesting and receiving segments identified by the unified manifest based on conditions of communication network and the streaming and playback client. In some embodiments, by receiving the MPD, or more generally the unified manifest, the streaming and playback client gets the description of each media content component. Accordingly, it is aware of the kind of media content components proposed in the media presentation and knows the HTTP URLs to be used for downloading the associated media segments. Therefore, the streaming and playback client can decide which media content components to download (via HTTP requests) and to play (i.e., to decode and to play after reception of the media segments).

In some embodiments, the method may further comprise downloading desired media components of the media presentation over desired periods of time.

In yet another aspect, the disclosure relates to a system of preselections for media processing, streaming and playback. The system comprises a unified manifest generation and media presentation preparation module configured to generate a unified manifest containing an MPD for a media content and prepare a media presentation of the media content accordingly, wherein the unified manifest lists all media components and tracks in ISOBMFF files related to the media content and supports preselections in DASH; a manifest deliver module configured to transmit the unified manifest to a streaming and playback client; a media segment delivery module configured to deliver segments identified by the unified manifest to the streaming and playback client; and a file download module configured for the streaming and playback client to download desired media components of the media presentation over desired periods of time.

In the following description, numerous specific details are set forth regarding the systems and methods of the disclosed subject matter and the environment in which such systems and methods may operate, etc., in order to provide a thorough understanding of the disclosed subject matter. In addition, it will be understood that the examples provided below are exemplary, and that it is contemplated that there are other systems and methods that are within the scope of the disclosed subject matter.

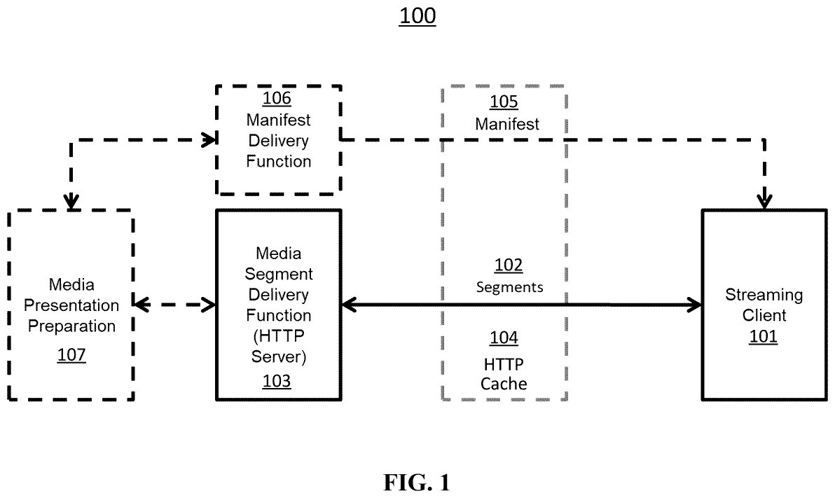

FIG. 1 shows an exemplary configuration of a generic adaptive streaming system 100. A streaming client 101 in communication with a server, such as HTTP server 103, may receive a manifest 105. The manifest 105 describes the content (e.g., video, audio, subtitles, bitrates, etc.). In this example, the manifest delivery function 106 may provide the streaming client 101 with the manifest 105. The manifest delivery function 106 and the server 103 may communicate with a media presentation preparation module 107. The streaming client 101 can request (and receive) segments 102 from the server 103 using, for example, HTTP cache 104 (e.g., a server-side cache and/or cache of a content delivery network). The segments can be, for example, associated with short media segments, such as 6-10 second long segments. For further details of an illustrative example, see e.g., w18609, “Text of ISO/IEC FDIS 23009-1:2014 4th edition”, July 2019, Gothenburg, SE, which is hereby incorporated by reference herein in its entirety.

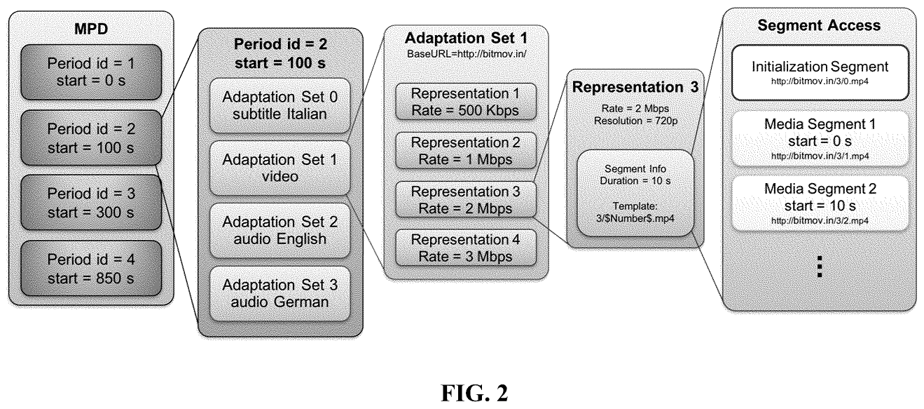

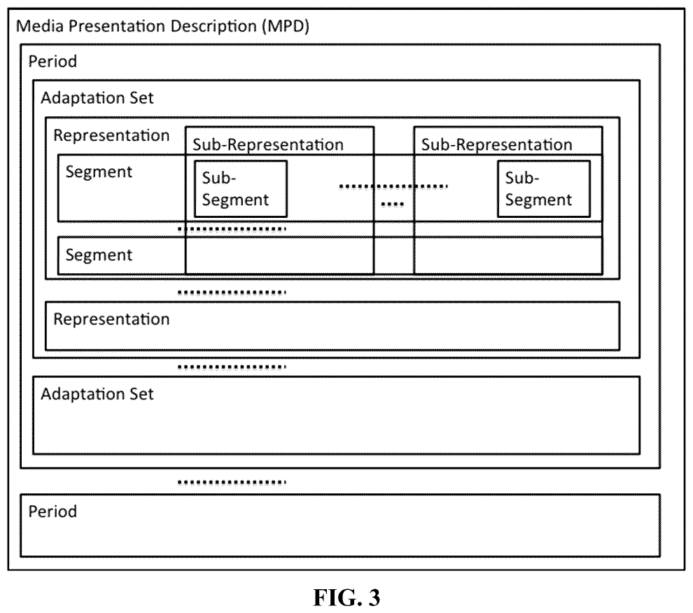

FIGS. 2-3 show an exemplary manifest that includes a media presentation description (MPD) in different illustrative views. The manifest can be, for example, the manifest 105 sent to the streaming client 101 shown in FIG. 1. In the context of DASH, this manifest is an XML (eXtensible Markup Language) encoded file, also called the MPD, containing appropriate information and attributes to describe the media content. The MPD is the first resource transmitted to a client in order to start a DASH based media delivery. In other words, the purpose of the MPD is to give location and timing information to the client to fetch and playback the media segments of a particular content. The MPD includes a series of periods that divide the content into different time portions that each have different IDs and start times (e.g., 0 seconds, 100 seconds, 300 seconds, etc.). Periods are the outermost part of the MPD. Each period can include a set of a number of adaptation sets (e.g., subtitles, audio, video, etc.). As shown in this example, Period ID=2 can have a set of associated adaptation sets, which includes Adaptation Set 0 for Italian subtitles, Adaptation Set 1 for video, Adaptation Set 2 for English audio, and Adaptation Set 3 for German audio. Each adaptation set can include a set of representations to provide different qualities of the associated content of the adaptation set. As shown in this example, Adaptation Set 1 includes Representations 1-4, each with a different supported bitrate (i.e., 500 Kbps, 1 Mbps, 2 Mbps, and 3 Mbps). Each representation can have segment information for the different qualities. As shown, for example, Representation 3 includes segment info, which has a duration of 10 seconds and a template, as well as segment access, which includes an initialization segment, and a series of media segments (e.g., in this example, ten-second-long media segments).

In some examples, such a media presentation is prepared by the media presentation preparation module 107 shown in FIG. 1. For this, the media presentation preparation module 107 encodes media content into a series of periods that each period includes a plurality of adaptation sets. Each adaptation set includes a plurality of media representations. The plurality of media representations may correspond to the plurality of bitrates, respectively. Additionally, the plurality of bitrates may correspond to a plurality of resolutions, respectively. Each media representation includes a plurality of media segments. Moreover, the media presentation preparation module 107 generates MPD metadata. At this point, the MPD metadata may include information on an internet location through which the streaming client 101 can access a plurality of media segments of each of a plurality of media representations.

In some embodiments, the streaming and playback client 101 can receive the MPD, and select (e.g., based on the client's adaptation parameters, such as bandwidth, CPU processing power, etc.) a representation for each period of the MPD (which may change over time, given different network conditions and/or client processing capabilities), and retrieve the associated segments for presentation to the user. As the client's adaptation parameters change, the client can select different representations accordingly (e.g., lower bitrate data if the available network bandwidth decreases and/or if client processing power is low, or higher bitrate data if the available bandwidth increases and/or if client processing power is high).

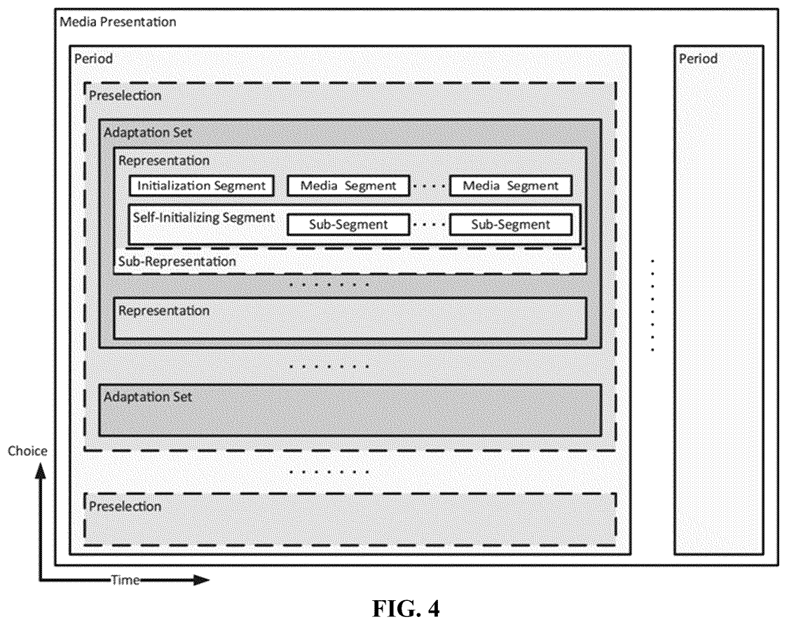

In some embodiments, the media presentation is prepared to include preselections of a subset of media components that are intended to be consumed jointly in the context (for example, in the context of DASH). That is, a preselection encompasses a subset of media components such that the media components can be selected and combined into a complete experience. Each preselection is uniquely identifiable and distinguishable, e.g., by language. The preselections define user experiences that can be selected by the streaming and playback client. In some examples, preselections are elements between Periods and AdaptationSets in the media presentation, as shown in FIG. 4. In some examples, preselections may be uniquely identified by, for example, a preselection descriptor defined in the MPD. In some embodiments, metadata characterizing the preselections may be included in or associated with the preselection descriptor. For example, projection type, region-wise packing type, language-wise packing type, content coverage, and/or region-wise quality ranking may be indicated.

In the file level (for example, the ISOBMFF level), preselections are defined as a set of one or more tracks representing one version of the media presentation for simultaneous decoding or presentation. A track belonging to a preselection is signaled by a presence of a PreselectionGroupBox within the track, and all tracks belonging to a preselection are encapsulated in a file, and how the tracks contributing to a preselection can be processed is signaled in a PreselectionProcessingBox.

In some embodiments, the streaming and playback client identifies the preselection descriptors that are present in the MPD. Based on the metadata included in or associated with the preselection descriptors, the client chooses preselection(s) to be streamed or played. The streaming and playback client may for example, choose the preselection that provides desired language.

In some embodiments, the streaming and playback client resolves which Adaptation Sets are part of the chosen preselection. If there are multiple Representations in an Adaptation Set belonging to the chosen preselection, the streaming and playback client chooses one Representation from the Adaptation Set to be received. The selection of Representations may be based on multiple factors, e.g., comprising the total bitrate of Representations required to decode the preselection relative to the prevailing or estimated network throughput.

However, as discussed in the background of this disclosure, the conventional adaptive streaming approach with preselection has a number of issues, particularly, when coming to deal with updating preselections and/or flexible (and late) binding between tracks and preselections.

To solve these issues, the disclosure provides a unified manifest approach to supporting preselections in DASH and ISOBMFF, as an alternative to the existing approach to add additional metadata on the ISOBMFF level to represent the “MPEG DASH Preselection” concept and to be sufficient to construct manifests for DASH and HLS.

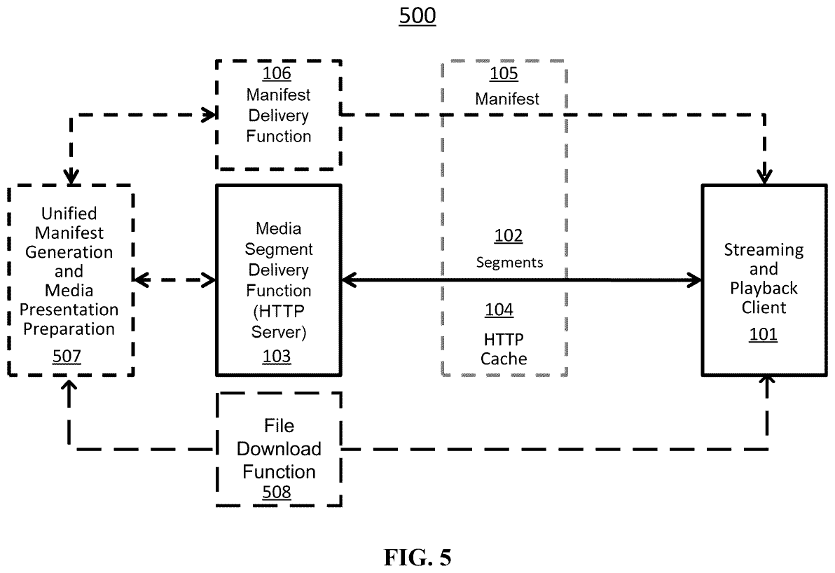

Referring to FIG. 5, an adaptive streaming system 500 supporting preselections in DASH and ISOBMF is shown according to some embodiments of the invention. The system 500 is similar to the system 100 show in FIG. 1, except that the media presentation preparation module 107 is replaced with a unified manifest generation and media presentation preparation module 507, and a file download function (module) 508 that is coupled between the unified manifest generation and media presentation preparation module 507 and the streaming and playback client 101 is included. In some examples, the unified manifest generation and media presentation preparation module 507 is configured to generate a unified manifest containing an MPD for a media content and prepare a media presentation of the media content accordingly. The unified manifest lists all media components and tracks in files (for example, ISOBMFF files), as an inventory list of all component materials, and supports preselections (for example, in DASH). In some examples, the file download module is configured for the streaming and playback client to download desired media components of the media presentation over desired periods of time.

Similar to the existing approach, the MPD includes a series of periods that divide the media content into different time portions; each period including a number of preselections; each preselection containing a number of adaptation sets; each adaptation set containing a number of representations; and each representation containing a number of segments. In some embodiments, the adaptation sets and the preselections conform to the DASH.

In order to avoid rewriting tracks and files for the preselection purpose, a novel approach according to embodiments of the invention is to define a unified manifest to: (1) list all media components, as an inventory list of all component materials related to a piece of media content; (2) contain sufficient metadata and constructs for signaling their adaptation switching relationship, and any modification of this relationship does not involve any change to the corresponding media components, especially files and tracks; (3) contain sufficient metadata and constructs for signal their preselection relationship, and any modification of this relationship does not involve any change to the corresponding media components, especially files and tracks; and (4) be sufficiently general to construct manifests for DASH and HLS.

The approach is alternative to the existing file/track-level approach, in the sense that it leaves media components (in tracks and files) alone and untouched, when coming to signaling their adaptative switching and preselection binding relationships.

In some examples, the unified manifest can take one of a standard form which can be used to derive manifests for DASH and HLS; a DASH form which can be used to generate manifests for DASH clients; and an HLS form which can be used to generate manifests for HLS clients.

According to the novel approach shown in FIG. 5, the unified manifest can be converted or customizing into a manifest (i.e., DASH manifest or HLS playlist) for the streaming and playback client, belonging to a client class based on some client characteristics (e.g., capabilities, geolocations, membership levels); and an ISOBMFF file can be generated according to a unified manifest to encapsulate all media materials related to a piece of content, to be either streamed or downloaded as a single file to the streaming and playback client, again belonging to a client class.

An embodiment of the novel approach is based on the DASH high level data model shown in FIG. 4 and the newly introduced metadata in ISOBMFF.

Another embodiment of the novel approach is to leverage derived visual tracks to consider using derived (visual) tracks in their own files, separate from those files for media components, to add additional metadata, as derivation operations on the ISOBMFF level, to represent the “MPEG DASH Preselection” concept, and to be sufficient to construct manifests for DASH and HLS. In this way, the preselection binding of media component tracks is encapsulated in derived tracks, external to the tracks of media components, and derived (visual) tracks serve the same function of unified manifests.

It should be noted that all or a part of the steps of the method according to the embodiments of the invention is implemented by hardware or a software module executed by a processor, or implemented by a combination thereof. In one aspect, the invention provide a system comprising at least one processor configured to perform the method of foveated rendering of omnidirectional media content as disclosed above.

Yet another aspect of the invention provides a non-transitory tangible computer-readable medium storing instructions which, when executed by one or more processors, cause a system to perform the above-disclosed method of preselections for media processing, streaming and playback. The computer executable instructions or program codes enable a computer or a similar computing system to complete various operations in the above disclosed method of preselections for media processing, streaming and playback. The storage medium/memory may include, but is not limited to, high-speed random access medium/memory such as DRAM, SRAM, DDR RAM or other random access solid state memory devices, and non-volatile memory such as one or more magnetic disk storage devices, optical disk storage devices, flash memory devices, other non-volatile solid state storage devices, or any other type of non-transitory computer readable recoding medium commonly known in the art.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A,

B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” maybe A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of preselections for media processing, streaming and playback, comprising:
generating a unified manifest containing a media presentation description (MPD) for a media content and preparing a media presentation of the media content accordingly, wherein the unified manifest lists all media components and tracks in files related to the media content and supports preselections; and
transmitting the unified manifest to a streaming and playback client.

2. The method of claim 1, wherein the MPD comprises a series of periods that divide the media content into different time portions; each period including a number of preselections; each preselection containing a number of adaptation sets; each adaptation set containing a number of representations; and each representation containing a number of segments.

3. The method of claim 2, wherein the unified manifest is configured such that when coming to signaling their adaptation switching and preselection binding relationships, the media components and tracks in files are left alone and untouched.

4. The method of claim 3, wherein the unified manifest contains sufficient metadata and constructs for signaling their adaptation switching relationship, such that any modification of the relationship does not involve any change to the corresponding media components and tracks in files.

5. The method of claim 1, wherein the unified manifest is in one of:
a standard form used to derive manifests for Dynamic Adaptive Streaming over HTTP (DASH) and HTTP (Hypertext Transfer Protocol) Live Streaming (HLS);
a DASH form used to generate DASH manifests for streaming and playback clients; and
an HLS form used to generate HLS playlists for HLS clients.

6. The method of claim 1, wherein the unified manifest is convertible or customizable into a DASH manifest or an HLS playlist for the streaming and playback client, based on client characteristics including capabilities, geolocations, and/or membership levels.

7. The method of claim 6, further comprising generating an ISO Base Media File Format (ISOBMFF) file according to the unified manifest to encapsulate all the media components related to the media content to be either streamed or downloaded as a single file to the streaming and playback client.

8. A method of preselections for media processing, streaming and playback, comprising, at a streaming and playback client:
requesting and receiving a unified manifest containing a media presentation description (MPD) for a media content, wherein the unified manifest lists all media components and tracks in files related to the media content and supports preselections; and
requesting and receiving desired segments identified by the unified manifest based on conditions of communication network and the streaming and playback client.

9. The method of claim 8, further comprising downloading desired media components of the media presentation over desired periods of time.

10. The method of claim 8, wherein the MPD comprises a series of periods that divide the media content into different time portions; each period including a number of preselections; each preselection containing a number of adaptation sets; each adaptation set containing a number of representations; and each representation containing a number of segments.

11. The method of claim 10, wherein the unified manifest is configured such that when coming to signaling their adaptation switching and preselection binding relationships, the media components and tracks in files are left alone and untouched.

12. The method of claim 11, wherein the unified manifest contains sufficient metadata and constructs for signaling their adaptation switching relationship, such that any modification of the relationship does not involve any change to the corresponding media components and tracks in files.

13. The method of claim 8, wherein the unified manifest is in one of:
a standard form used to derive manifests for Dynamic Adaptive Streaming over HTTP (DASH) and HTTP (Hypertext Transfer Protocol) Live Streaming (HLS);
a DASH form used to generate DASH manifests for streaming and playback clients; and
an HLS form used to generate HLS playlists for HLS clients.

14. The method of claim 8, wherein the unified manifest is convertible or customizable into a DASH manifest or an HLS playlist for the streaming and playback client, based on some client characteristics including capabilities, geolocations, and/or membership levels.

15. The method of claim 14, wherein an ISO Base Media File Format (ISOBMFF) file can be generated according to the unified manifest to encapsulate all the media components related to the media content to be either streamed or downloaded as a single file to the streaming and playback client.

16. A system of preselections for media processing, streaming and playback, comprising:
a unified manifest generation and media presentation preparation module configured to generate a unified manifest containing a media presentation description (MPD) for a media content and prepare a media presentation of the media content accordingly, wherein the unified manifest lists all media components and tracks in files related to the media content and supports preselections;
a manifest deliver module configured to transmit the unified manifest to a streaming and playback client;
a media segment delivery module configured to deliver segments identified by the unified manifest to the streaming and playback client; and
a file download module configured for the streaming and playback client to download desired media components of the media presentation over desired periods of time.
